(19) United States
(12) Patent Application Publication
(10) Pub. No.: US 2003/0015913 A1
(43) Pub. Date: Jan. 23, 2003

(54) Axle housing and method of producing the same

(75) Inventors: Yukikazu Ueno, Toyota-shi (JP); Setsuko Asadachi, Toyota-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: TOYOTA JIDOSHA KABUSHIKI KAISHA, Toyota-shi (JP)

(21) Appl. No.: 10/200,287

(22) Filed: Jul. 23, 2002

(30) Foreign Application Priority Data
Jul. 23, 2001 (JP) 2001-221506

(51) Int. Cl. B60B 35/16

(52) U.S. Cl. 301/137

(57) ABSTRACT

A housing body of an axle housing is produced by: bending widthwise opposite portions of a sheet material having a substantially developed shape of the axle housing, bending inwards edge portions adjacent to widthwise opposite sides of the sheet material, and forming two longitudinally opposite end portions of the sheet material into a tubular shape. Further, a generally rhombic opening is formed in a longitudinally middle portion of the sheet material. The axle housing is produced by mounting a generally rhombic cover plate onto the housing body so as to cover the opening.

### INCORPORATION BY REFERENCE

The disclosure of Japanese Patent Application No. 2001-221506 filed on Jul. 23, 2001 including the specification, drawings and abstract is incorporated herein by reference in its entirety.

### BACKGROUND OF THE INVENTION

1. Field of Invention

The invention relates to an axle housing and a method of producing the axle housing.

2. Description of Related Art

In FR (front-engine rear-drive) vehicles in which rear wheels are driven by an engine installed in a front portion of the vehicle, drive force transmitted from the engine via a propeller shaft is distributed to right and left rear axle shafts (rear-wheel axles) by a differential gear. The rear axle shafts are disposed in an axle housing and are mounted in the vehicle.

The axle housing is a hollow tubular body that includes a longitudinally middle portion that is swollen or expanded or has a greater width than the other portions. The expanded middle portion forms a gear case that houses a differential gear. Two tubular portions extend from opposite sides of the gear case, and the axle shafts are inserted in the tubular portions. The gear case has a generally circular mount hole in which the differential gear is mounted.

FIG. 5 is an exploded perspective view showing one example of the axle housing as described above. In general, the axle housing is produced by joining many components or parts together, as in the example of FIG. 5.

In the axle housing 100, the gear case is formed by arc-welding four parts, that is, an upper part 101A, a lower part 101B, a gear cover plate 103, and a ring plate 105. Two pipes 102 are then joined to the opposite sides of the gear case by friction welding. Reinforcing members 106 are mounted on the assembly of the gear case and the two pipes 102 by arc welding so as to cover two joints between the gear case and the pipes 102. In this manner, the axle housing 100 is produced.

Since the axle housing 100 as shown in FIG. 5 requires a large number of parts and a large number of welding sites for production thereof, it is difficult to produce the axle housing 100 with high accuracy, and the production cost is undesirably increased. Furthermore, the large number of welding sites is likely to cause oil leakage and a reduction in the mechanical strength thereof. In particular, the joints between the gear case and the pipes 102, which are formed merely by friction welding, have difficulty in providing sufficiently high strength, and thus require the reinforcing members 106 as described above, resulting in an increase in the overall weight of the axle housing.

In view of the above problems, an axle housing as disclosed in Japanese Laid-open Patent Publication No. 11-208207 is proposed in which a gear case and two tubular portions are produced from a single sheet material, in an attempt to reduce the number of parts and the number of welding sites.

FIGS. 6A to 6D illustrate a process of producing the axle housing as described above. The axle housing is produced by bending and drawing a sheet material that is formed by cutting a metal sheet into a generally developed (or unfolded) shape of the housing.

According to the process as disclosed in the above-identified publication, a protruding portion 203 having a generally hemispherical shape and providing a space for housing a differential gear is formed in a middle portion of a cut sheet material 200 by a drawing process, as shown in FIG. 6A. Then, a preliminary bending process is carried out for bending, by press, two widthwise opposite portions (i.e., side portions) of the sheet material 200 that are opposite to each other in the width direction of the sheet material 200, as shown in FIG. 6B. Thereafter, the sheet material 200 is curved about the axis that extends in the longitudinal direction thereof, to be thus formed into a generally U shape in cross section, as shown in FIG. 6C.

Subsequently, as shown in FIG. 6D, the sheet material 200 is further curved about the longitudinal axis so as to form an axle housing. In this process, two longitudinally opposite end portions 202 of the sheet material 200 are subjected to drawing until two widthwise opposite side faces B contact with each other, and are thus formed into a generally tubular shape. A middle portion 201 of the sheet material 200 is also subjected to drawing so that a circular mount hole 204 is defined by widthwise opposite side faces A that are opposite to each other in the width direction of the sheet material. Then, the widthwise opposite side faces B that are in contact with each other are joined by welding. In this manner, the axle housing as shown in FIG. 6D is formed from a piece of sheet material.

With the method as described above, the axle housing can be certainly produced from a reduced number of parts, with a reduced number of welding sites. However, it is extremely difficult to produce the axle housing in the manner as described above.

In the production of the axle housing as disclosed in the above-identified publication, it is necessary to draw the widthwise opposite sides of the middle portion of the sheet material 200 by a considerably large degree until the circular mount hole 204 is formed. A considerably high processing technique is required for achieving such a large degree of drawing without causing a twist or a breakage or tear of the material. It is thus difficult to manufacture axle housing with sufficiently high efficiency or productivity.

In order to allow the drawing process as described above, various restrictions are imposed on the design (e.g., the shape) of the axle housing. For example, the tubular portions of the axle housing through which the axle shafts extend must be formed into a tapered shape.

### SUMMARY OF THE INVENTION

An object of the invention is to provide an axle housing which can be easily produced, requiring a reduced number of parts and a reduced number of welding sites. It is another object of the invention to provide a method of producing an axle housing by a simplified process, requiring a reduced number of parts and a reduced number of welding sites.

To accomplish the above objects, an axle housing includes a pair of tubular portions formed by bending two longitudinally opposite end portions of a sheet material having a substantially developed shape of the axle housing, about an axis extending in a longitudinal direction of the sheet material, until widthwise opposite sides of each of the longitudinally opposite end portions contact with each other; an expanded portion formed by bending a longitudinally middle portion of the sheet material about the axis extending in the longitudinal direction thereof, such that an opening having a generally rhombic shape is formed between the widthwise opposite sides of the longitudinally middle portion; and a cover plate that has a generally rhombic shape and is mounted on the expanded portion so as to cover the opening.

In the axle housing constructed as described above, a central gear case that houses a differential gear and the tubular portions through which right and left axle shafts are inserted are formed from a single piece of sheet material by bending, to provide a housing body. The axle housing consists of two parts, i.e., the housing body formed by bending and the cover plate. The expanded portion formed at the middle of the axle housing to provide a gear case is subjected to a bending process so that an opening having a generally rhombic shape is formed in the expanded portion. Thus, the housing body can be relatively easily formed without requiring a great amount of drawing or bending of the material. It is thus possible to reduce the number of parts of the axle housing while assuring sufficiently high efficiency or ease in processing the parts of the axle housing.

The reduction in the number of parts needed for forming the axle housing leads to a reduction in joining operations for joining the parts by, for example, welding. Furthermore, since the number of joints between the parts is reduced, ensuring sufficiently high strength and preventing oil leakage become easy. In particular, base or proximal portions of the tubular portions at which stress is concentrated are formed integrally with the expanded portion, thus assuring sufficiently high strength

In one preferred embodiment of the invention, a generally circular mount hole that receives a differential carrier is formed in the cover plate.

With this arrangement, the mount hole is formed in the cover plate, rather than in the sheet material to be subjected to a bending process. Thus, the mount hole can be easily formed in the axle housing. Furthermore, differential gears having different sizes, for example, can be mounted in the axle housing merely by changing the cover plate but without changing or replacing the housing body (the article formed by bending) Thus, it is possible to easily manufacture axle housings that may be used with different types of differential gears.

A generally circular mount hole may also be formed in the housing body. In this case, the mount hole is formed after a bending process for forming the housing body, thus avoiding deformation of the hole during the bending process.

According to a second aspect of the invention, there is provided a method of producing an axle housing including an expanded middle portion, comprising forming a sheet material having a substantially developed shape of the axle housing, the sheet material including a longitudinally middle portion having a greater width than longitudinally opposite end portions of the sheet material, bending the longitudinally opposite end portions of the sheet material into a tubular shape until widthwise opposite sides of each of the longitudinally opposite end portions contact each other, bending the longitudinally middle portion of the sheet material about an axis extending in a longitudinal direction of the sheet material such that an opening having a generally rhombic shape is formed between widthwise opposite sides of the longitudinally middle portion; and mounting a cover plate having a generally rhombic shape on the longitudinally middle portion so as to cover the opening.

According to the method as described above, a central gear case that houses a differential gear and the tubular portions through which right and left axle shafts are inserted are formed from a single piece of sheet material by bending, to provide a housing body. The axle housing consists of two parts, i.e., the housing body formed by bending and the cover plate. The expanded portion formed at the middle of the axle housing to provide a gear case is subjected to a bending process so that an opening having a generally rhombic shape is formed in the expanded portion. Thus, the housing body can be relatively easily formed without requiring a great amount of drawing or bending of the material. It is thus possible to reduce the number of parts of the axle housing while assuring sufficiently high efficiency or ease in processing the parts of the axle housing.

According to a third aspect of the invention, there is provided a method of producing an axle housing including an expanded middle portion, comprising forming a sheet material having a substantially developed shape of the axle housing, the sheet material including a longitudinally middle portion having a greater width than longitudinally opposite end portions of the sheet material, first bending widthwise opposite portions of the sheet material, second bending inwards edge portions of the widthwise opposite portions of the sheet material that have been bent in the first bending step, such that the edge portions adjacent to widthwise opposite sides of the sheet material become close to each other, forming an opening having a generally rhombic shape in the longitudinally middle portion of the sheet material through the first bending step and the second bending step, third bending each of longitudinally opposite end portions of the sheet material that have been bent in the second bending step, into a tubular shape, and mounting a cover plate having a generally rhombic shape onto the longitudinally middle portion of the sheet material so as to cover the opening.

According to the method as described above, the tubular portions through which the axle shafts are inserted are formed in the first to third bending steps. Through the first and second bending steps, the generally rhombic opening is formed in a longitudinally middle portion of the sheet material. Then, the cover plate similarly formed in a generally rhombic shape is mounted on the housing body so as to cover the opening, whereby the axle housing is produced. In this method, the sheet material is subjected to bending so that the generally rhombic opening remains in the longitudinally middle portion of the sheet material. Accordingly, the housing body can be relatively easily formed without requiring a great amount of drawing or bending of the material. It is thus possible to produce the axle housing with a reduced number of parts of the axle housing while assuring sufficiently high efficiency or ease in processing the parts. Furthermore, the reduction in the number of parts needed leads to a reduction in welding sites or joints, thus making it easy to ensure sufficiently high strength of the resulting axle housing and prevent oil leakage.

The method of producing the axle housing according to the second or third aspect of the invention may further include a step of forming a generally circular mount hole in the cover plate.

In the production method as described just above, the mount hole is formed in the cover plate, rather than in the sheet material to be subjected to a bending process. Thus, the mount hole can be easily formed in the axle housing. Furthermore, differential gears having different sizes, for example, can be mounted in the axle housing merely by changing the cover plate but without changing or replacing the housing body (the article formed by bending). It is thus possible to easily manufacture axle housings that may be used with different types of differential gears.

### BRIEF DESCRIPTION OF THE DRAWINGS

The foregoing and further objects, features and advantages of the invention will become more apparent from the following description of exemplary embodiments with reference to the accompanying drawings, in which like numerals are used to represent like elements and wherein:

FIG. 1 is an exploded perspective view of an axle housing as one exemplary embodiment of the invention;

FIG. 2 is a sectional view of a generally middle, expanded portion of the axle housing as shown in FIG. 1;

FIGS. 3A to 3D are perspective views of the axle housing as shown in FIG. 1 and sectional views of a generally middle portion thereof, illustrating a process of producing the axle housing; as another exemplary embodiment of the invention;

FIG. 5 is an exploded perspective view showing a known example of an axle housing; and

FIGS. 6A to 6D are perspective views of another known example of an axle housing, illustrating a process of producing the axle housing.

### DETAILED DESCRIPTION OF PREFERRED EMBODIMENTS

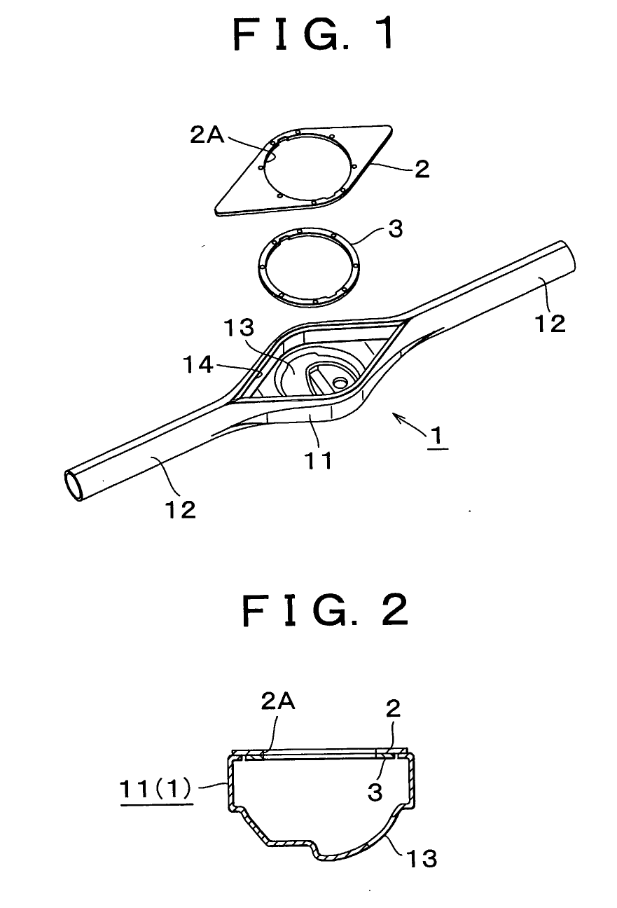

One exemplary embodiment of the invention will be descried in detail with reference to the drawings. FIG. 1 is an exploded perspective view of the structure of an axle housing according to the present embodiment of the invention. As shown in FIG. 1, the axle housing of this embodiment includes three parts, namely, a housing body 1, a cover plate 2 and a ring plate 3.

The housing body 1 is formed as a hollow tubular body having an expanded or swollen middle portion 11. The expanded middle portion (hereinafter referred to as “expanded portion”) 11 of the housing body 1 forms a gear case that houses a differential gear. The housing body 1 further includes tubular portions 12 extending from two opposite sides of the expanded portion 11. The tubular portions 12 are arranged to receive right and left axle shafts, respectively. The expanded portion 11 is formed with a protruding portion 13 having a generally hemispherical shape and providing a space for housing the differential gear, and is also formed with an opening 14 having a generally rhombic shape such that the opening 14 is aligned with the protruding portion 13 as viewed in a direction perpendicular to the longitudinal direction of the housing body 1.

The cover plate 2 consists of a flat plate having a generally rhombic shape, and the shape and size of the cover plate 2 are determined so that the cover plate 2 covers the opening 14 formed at the middle of the housing body 1. A central portion of the cover plate 2 has a generally circular mount hole 2A for mounting the differential gear in the axle housing.

The ring plate 3 is joined by, for example, spot welding or arc welding, to a surface of the cover plate 2 that provides an inner circumferential surface of the axle housing. The ring plate 3 serves to reinforce a mounting portion for mounting the differential gear in the axle housing.

As shown in FIG. 2, which illustrates the sectional structure of a middle portion of the axle housing, the cover plate 2 and the ring plate 3 are integrated and welded to the housing body 1 so as to cover the opening 14. In this manner, the axle housing is produced.

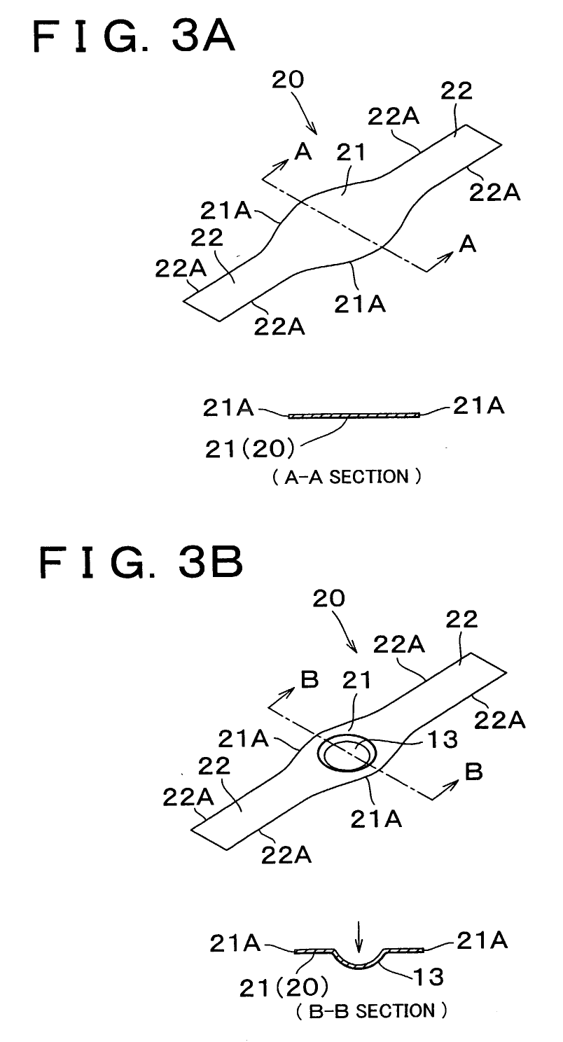

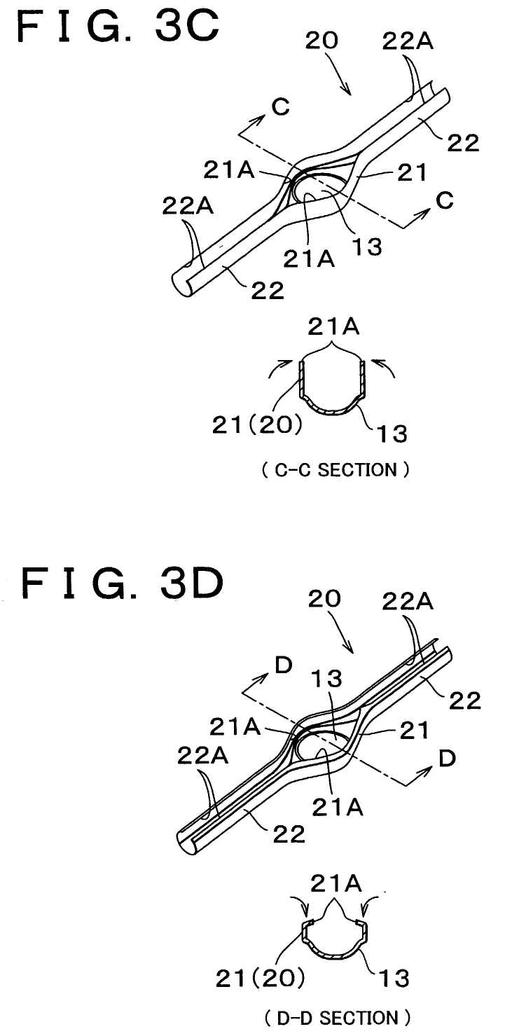

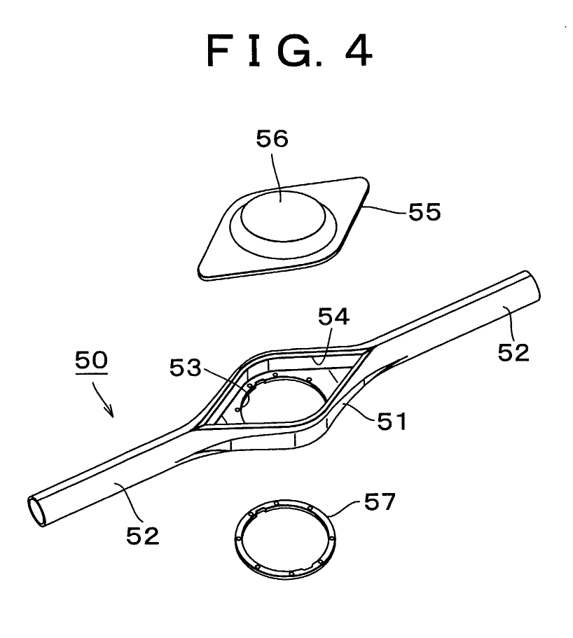

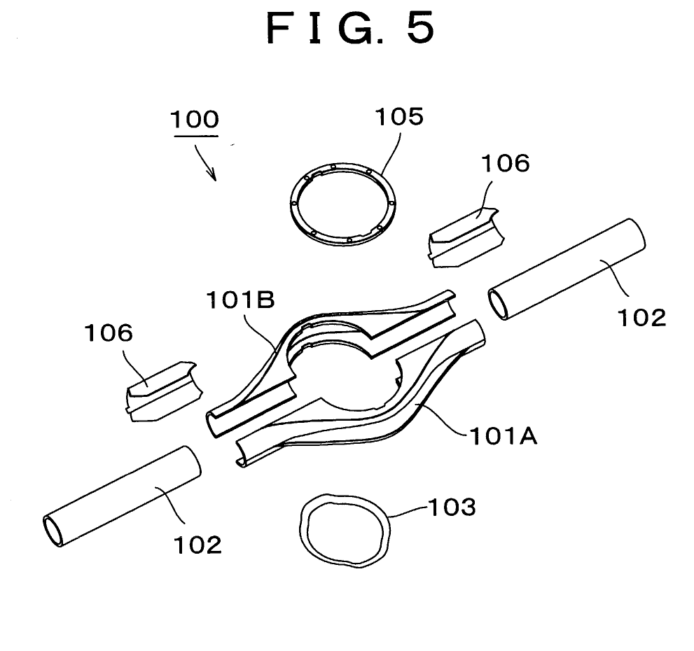

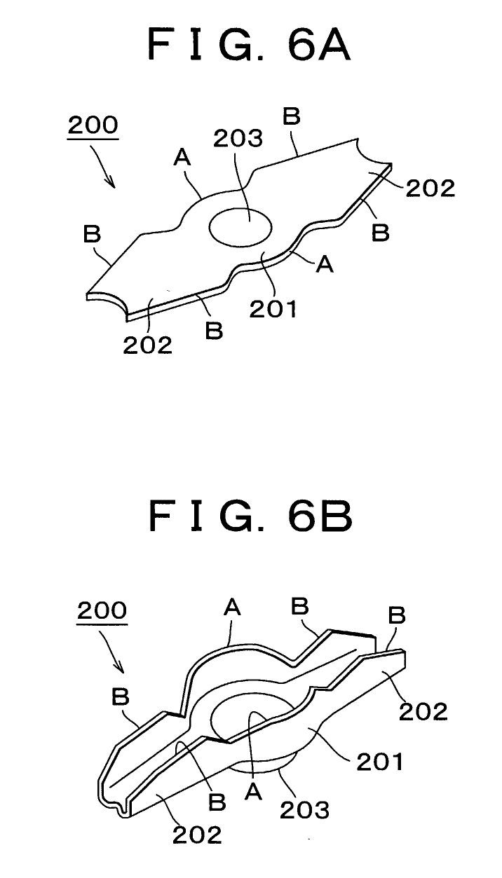

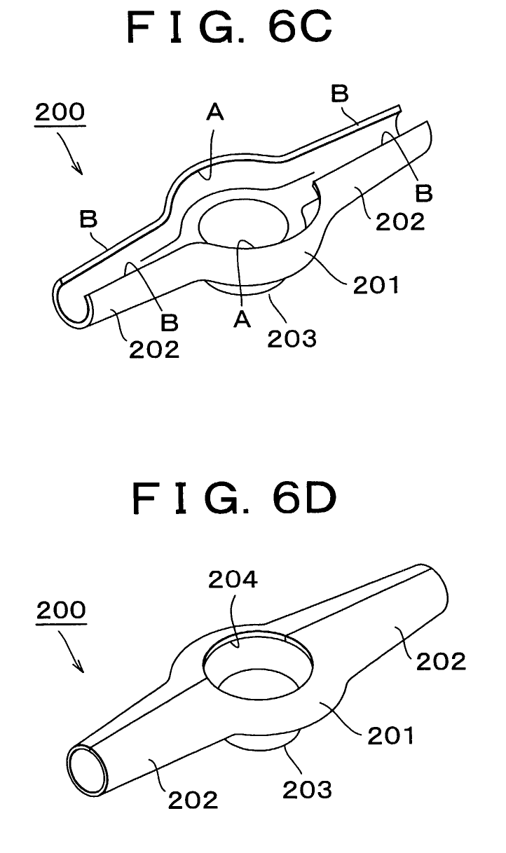

In the axle housing of this embodiment, the housing body 1 is formed from a single piece of sheet material by bending the sheet material through a press. FIG. 3A through 3D illustrate process steps of forming the housing body 1.

1. Formation of Sheet Material (FIG. 3A)

A sheet material 20 as a material of the housing body 1 is formed by cutting the sheet material 20 out of a metal sheet by punching or blanking, or the like, through a press. The sheet material 20 is formed into a generally developed (or unfolded) shape of the housing body 1. In this embodiment, the sheet material 20 is formed as a generally belt-shaped flat plate as shown in FIG. 3A by example. The sheet material 20 includes a longitudinally middle portion 21 having a relatively large width, which portion 21 provides the expanded portion 11 as described above.

2. Formation of Protruding Portion (FIG. 3B)

A hemispherical protruding portion 13 is formed in the longitudinally middle portion 21 of the cut sheet material 20 by drawing through press. Thus, the hemispherical protruded portion 13 is formed integrally with the housing body 1.

3. U-shape Bending Process (FIG. 3C)

Next, the sheet material 20 with the protruding portion 13 is bent about the axis extending in the longitudinal direction thereof, and is thus formed into a generally U shape in cross section. In this process, the sheet material 20 is bent at its portions that are spaced a predetermined distance from two widthwise opposite ends 21A, 22A of the sheet material 20 so that widthwise opposite bent portions stand substantially upright as shown in FIG. 3C. In this manner, peripheral side surfaces of the expanded portion 11 are formed at the middle of the housing body 1.

4. Inward Bending Process (FIG. 3D)

Following the U-shape bending process, edge portions of the widthwise opposite bent portions of the sheet material 20, which edge portions are close to the widthwise opposite sides 21A, 22A, are further bent inwards so as to become closer to each other.

5. Final Bending Process

Following the inward bending process, two longitudinally opposite end portions 22 of the sheet material 20 are bent into an 0 shape until their sides 22A are brought into contact with each other. The two sides 22A are joined to each other by welding, thereby forming tubular portions 12. After trimming of suitable portions, the housing body 1 as shown in FIG. 1 is formed.

In the U-shape bending process and the inward bending process, the middle portion 21 of the sheet material 20 is bent only by substantially the same amounts as the longitudinally opposite end portions 22 of the sheet material 20. As a result, a generally rhombic opening 14 remains in the expanded portion 11 formed at the middle of the housing body 1. In this embodiment, the cover plate 2 having a similar rhombic shape is welded to and joined to the periphery of the opening 14 so as to cover the opening 14, thereby forming an axle housing. In this embodiment, a portion of the housing body 1 that defines or surrounds the opening 14 is formed with a flat surface through the trimming as described above, thereby forming a flange to which the cover plate 2 is welded and joined.

Described above are details of the process of forming the housing body 1 of the axle housing according to the present embodiment of the invention. In this embodiment, the housing body 1 is formed by bending the sheet material 20 about the axis extending in the longitudinal direction of the sheet material 20. By performing a bending process so as to form the generally rhombic opening 14 in the expanded portion 11 at the middle of the sheet material 20, the sheet material 20 is prevented from being subjected to a considerably large degree of drawing, thus permitting the housing body 11 to be relatively easily formed.

The illustrated embodiment may yield advantages as follows.

(1) In the embodiment, the housing body 1 is formed by bending the sheet material 20 such that the opening 14 having a generally rhombic shape remains in the expanded portion 11 of the housing body 1. Therefore, the housing body 1 can be relatively easily formed without requiring considerable drawing of the sheet material 20. Thus, the axle housing can be easily produced with a reduced number of parts, while at the same time assuring high efficiency in processing the parts.

(2) The reduction in the number of parts needed for forming the axle housing leads to a reduction in joining operations for joining the parts by, for example, welding. Furthermore, since the number of joints between the parts is reduced, it becomes easy to secure sufficiently high strength and prevent oil leakage. In particular, base or proximal portions of the tubular portions 12 at which stress is concentrated are formed integrally with the expanded portion 11, thus assuring sufficiently high strength.

(3) In this embodiment, the mount hole 2A can be easily formed in the cover plate 2, not in the sheet material 20 that is subjected to the bending process.

(4) With the arrangement in which the mount hole 2A is formed in the cover plate 2, differential gears having different sizes, for example, can be mounted in the axle housing merely by changing the cover plate 2A but without changing or replacing the housing body 1. It is thus possible to easily manufacture axle housings that may be used with different types of differential gears.

The illustrated embodiment of the invention may be modified as follows. While the mount hole 2A for mounting a differential gear in the axle housing is formed in the cover plate 2 in the illustrated embodiment, it is also possible to form a mount hole in a housing body formed from a sheet material, as shown in FIG. 4.

In the embodiment as shown in FIG. 4, a housing body 50 having an expanded portion 51 and tubular portions 52 is formed from a sheet material as in the first embodiment. Unlike the first embodiment, the housing body 50 has a mount hole 53 formed in the expanded portion 51. On the other hand, a cover plate 55 is formed with a protruding portion 56 having a generally hemispherical shape. The cover plate 55 is joined to the periphery of a generally rhombic opening 54 formed in the expanded portion 51 of the housing body 50, and a ring plate 57 is joined to the periphery of the mount hole 53 formed in the expanded portion 51 of the housing body 50. In this manner, the axle housing is produced.

With this arrangement, too, it is possible to produce an axle housing with a reduced number of parts, without requiring a difficult bending process that involves a considerably large degree of drawing. Therefore, the above-stated advantages (1), (2) can be provided.

The axle housing produced according to the second embodiment of the invention may suffer from deformation of the mount hole 53 during a bending process of the sheet material. However, this possibility can be avoided if the mount hole 53 is formed after the bending process to form the housing body 1.

In the illustrated embodiments, the ring plate 3 (57) is joined to the periphery of the mount hole 2A(53) so as to secure sufficiently high strength of the hole 2A(53). However, the ring plate 3(57) may be omitted if required strength is ensured. It is also possible to form the mount hole 2A, 53 in the cover plate 2 or the housing body 50 such that a ring plate is formed integrally with the cover plate 2 or the housing body 50.

In the illustrated embodiments, the housing body is formed by bending a sheet material in three separate steps, that is, the U-shape bending process, the inward bending process and the final bending process (or a four steps that further include a process of forming a protruding portion). However, the number of bending steps may be increased as needed or may be reduced if possible.

While the invention has been described with reference to what are presently considered to be preferred embodiments thereof, it is to be understood that the invention is not limited to the disclosed embodiments or constructions. On the contrary, the invention is intended to cover various modifications and equivalent arrangements. In addition, while the various elements of the invention are shown in various combinations and configurations, which are exemplary, other combinations and configurations, including more, less or only a single embodiment, are also within the spirit and scope of the invention.

What is claimed is:

1. An axle housing comprising:
a pair of tubular portions formed by bending two longitudinally opposite end portions of a sheet material substantially shaped like the axle housing, about an axis extending in a longitudinal direction of the sheet material, until widthwise opposite sides of each of the longitudinally opposite end portions contact each other;
an expanded portion formed by bending a longitudinally middle portion of the sheet material about the axis extending in the longitudinal direction, such that an opening having a generally rhombic shape is formed between the widthwise opposite sides of the longitudinally middle portion; and
a cover plate that has a generally rhombic shape and is mounted on the expanded portion so as to cover the opening.

2. The axle housing according to claim 1, wherein a generally circular mount hole that receives a differential carrier is formed in the cover plate.

3. The axle housing according to claim 1, wherein a generally circular mount hole in which a differential carrier is received is formed in a bottom wall of the opening of the expanded portion.

4. A method of producing an axle housing including an expanded middle portion, comprising the steps of:
providing a sheet material substantially shaped like the axle housing, the sheet material including a longitudinally middle portion having a greater width than longitudinally opposite end portions of the sheet material;
bending the longitudinally opposite end portions of the sheet material into a tubular shape until widthwise opposite sides of each of the longitudinally opposite end portions contact each other;
bending the longitudinally middle portion of the sheet material about an axis extending in a longitudinal direction of the sheet material such that an opening having a generally rhombic shape is formed between widthwise opposite sides of the longitudinally middle portion; and
mounting a cover plate having a generally rhombic shape on the longitudinally middle portion so as to cover the opening.

5. The method according to claim 4, further comprising the step of forming a generally circular mount hole in the cover plate.

6. The method according to claim 4, further comprising the step of forming a generally circular mount hole in the longitudinally middle portion of the sheet material.

7. A method of producing an axle housing including an expanded middle portion, comprising:
providing a sheet material including a longitudinally middle portion having a greater width than longitudinally opposite end portions of the sheet material;
first bending widthwise opposite portions of the sheet material;
second bending inwards edge portions of the widthwise opposite portions of the sheet material that have been bent in the first bending step, such that the edge portions adjacent to widthwise opposite sides of the sheet material become close to each other;
forming an opening having a generally rhombic shape in the longitudinally middle portion of the sheet material through the first bending step and the second bending step;
third bending each of longitudinally opposite end portions of the sheet material bent in the second bending step, into a tubular shape; and
mounting a cover plate having a generally rhombic shape onto the longitudinally middle portion of the sheet material so as to cover the opening.

8. The method according to claim 7, further comprising the step of forming a generally circular mount hole in the cover plate.

9. The method according to claim 7, further comprising the step of forming a generally circular mount hole in the longitudinally middle portion of the sheet material.
